(19) United States
(12) Patent Application Publication
(10) Pub. No.: US 2004/0118813 A1
(43) Pub. Date: Jun. 24, 2004

(54) Method of manufacturing metal cover with blind holes therein

(76) Inventor: Wente Lai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/346,966

(22) Filed: Jan. 17, 2003

(30) Foreign Application Priority Data
Dec. 20, 2002 (TW) 91136961

(51) Int. Cl. C23F 1/00; B44C 1/22; C03C 15/00; C03C 25/68

(52) U.S. Cl. 216/84

(57) ABSTRACT

A method of manufacturing a metal cover (1) with blind holes (3) therein includes the steps of: step (60), preparing a metal substrate; step (62), covering the metal substrate with a protective film; step (64), forming holes in the protective film according to an intended pattern of the blind holes in the metal cover, thus exposing the metal surface through the holes; step (66), etching the metal substrate in the exposed areas to form the blind holes; and step (68), removing a remainder of the protective film from the metal substrate, thereby obtaining the finished metal cover.

### FIELD OF THE INVENTION

The present invention relates to a method of manufacturing a perforated metal cover, and particularly to a method of manufacturing a metal cover with blind holes therein.

### BACKGROUND OF THE INVENTION

A conventional method to form blind holes in a solid surface, as described in U.S. Pat. No. 5,143,578, uses a laser engraving process. The method disclosed uses a pulsed laser beam impinging on a solid surface to engrave a series of consecutive cells in the surface. The pulses of the laser beam are delivered in a series of consecutive groups each having two or more consecutive pulses. Each of said groups forms an individual cell in the solid surface. However, it is difficult to form deeper blind holes on a metallic surface using the laser engraving process. Additionally, the laser engraving method is relatively expensive and consumes large amounts of energy to engrave blind holes in a metal surface.

Therefore, an improved method for manufacturing a metal cover with blind holes therein is desired to overcome the disadvantages of the prior art.

### SUMMARY OF THE INVENTION

A main object of the present invention is to provide a relatively low-cost method of manufacturing a metal cover with blind holes therein.

Another object of the present invention is to provide a method of manufacturing a metal cover with blind holes therein, which leaves the cover with a brilliant appearance and a high luster.

A method of manufacturing a metal cover with blind holes therein includes the steps of: preparing a metal substrate; covering the metal substrate with a protective film; forming holes in the protective film according to the pattern of the blind holes on the cover, thus exposing the metal surface through the holes; etching the metal substrate in the exposed areas to form blind holes; and removing the protective film from the metal substrate to obtain the finished metal cover.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a perspective view of a metal cover with blind holes therein manufactured according to a method of the present invention; and

FIG. 2 is a flow chart of a process of the method of manufacturing the metal cover of FIG. 1 according to a preferred embodiment of the present invention.

### DETAILED DESCRIPTION OF THE INVENTION

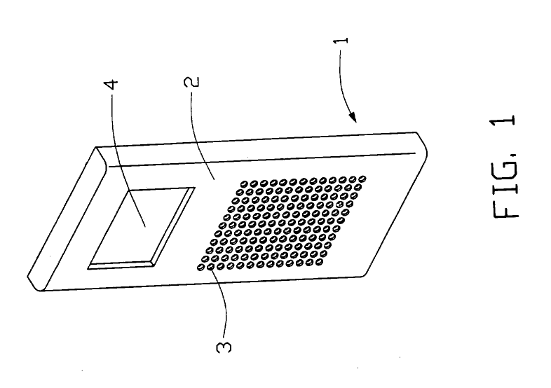

Referring now to the drawings in detail, FIG. 1 shows a metal cover 1. The metal cover 1 includes a metal shell 2, with a plurality of blind holes 3 being formed in the metal shell 2 in a geometric pattern. In a preferred embodiment of the present invention, the metal cover 1 is made of aluminum.

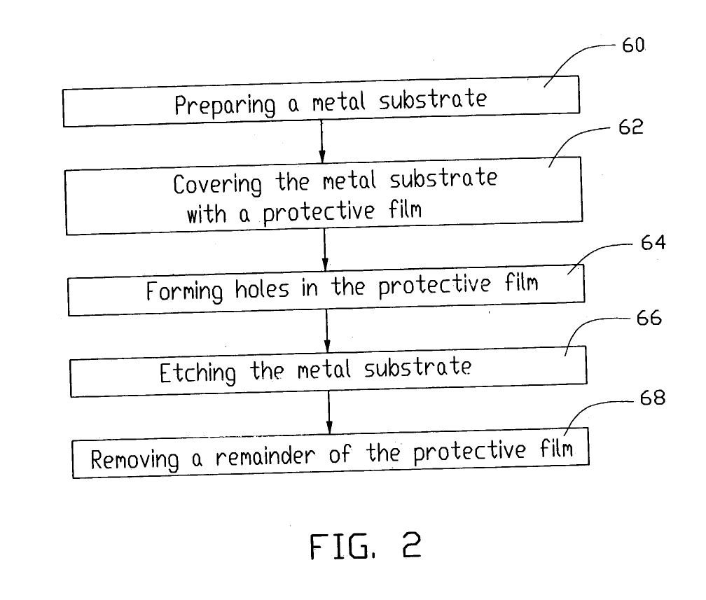

FIG. 2 shows a method of manufacturing the metal cover 1 of FIG. 1, which includes the steps of: step 60, preparing a metal substrate; step 62, covering the metal substrate with a protective film; step 64, forming holes in the protective film on the metal substrate to expose the metal substrate beneath the film; step 66, etching the metal substrate in the exposed areas; and step 68, removing a remainder of the protective film from the metal substrate, thus obtaining the finished metal cover 1 of FIG. 1.

In step 60, a piece of aluminum sheet is first cut into a plurality of aluminum substrates about the size of the cover 1. Secondly, the aluminum substrates are stamped into three-dimensional shapes, at the same time forming an opening 4 according to use requirements. After being stamped, the aluminum substrates have burrs on them and the edges of the substrates are rough, so it is necessary and important to grind the substrates. The grinding process can be performed in a vibratory finishing machine, in which ceramic grindstones are used as a finishing media, and detergent and brightener are added and mixed for the grinding process. The grinding process is carried out for a predetermined time, until the aluminum substrates exhibit smooth and brilliant surfaces. Other grinding processes can also be used in place of the above process to grind the aluminum substrates. Then, the aluminum substrates are pretreated, which can include mechanical polishing, degreasing, chemical polishing, washing and drying.

In step 62, the pretreated aluminum substrate is covered with a protective film using a painting or printing process. The protective film, can be, for instance, an acid-resistant printing ink, an alkali-resistant printing ink, or a printing ink which is both acid-resistant and alkali-resistant. The protective film must protect portions of the aluminum substrate covered by it from being etched.

In step 64, through holes are formed in the protective film according to a desired pattern of the blind holes 3 in the finished cover 1, thus leaving a remainder of the protective film on the aluminum substrate. The through holes expose the aluminum substrate beneath the protective film and can be formed using a laser engraving process. To perform the laser engraving, a pattern procedure is first programmed in a computer to control a laser to engrave the through holes in the protective film according to the pattern of the blind holes 3 desired, the aluminum substrate is then fixed in a laser machine and a laser beam is directed onto the protective film covered the aluminum substrate. The engraving process is controlled by the pattern procedure, and substantially burns off the protective film over the areas of the substrate where the blind holes 3 will be formed. Thus a plurality of through holes arranged in the desired pattern is formed in the protective film, exposing the aluminum substrate in areas where the blind holes 3 are to be formed. Other laser engraving processes can be used in place of the above engraving process. Machining methods, such as drilling, can also be used to form through holes in the protective film.

In step 66, the aluminum substrate is dipped into an etching tank containing an etching solution, so that the blind holes are etched in the aluminum substrate where the through holes expose the base surface of the substrate. The etching solution can be an alkali solution, such as a sodium hydroxide solution. When using a sodium hydroxide solution as an etching solution, a concentration of the free sodium hydroxide should be in a range of 10 to 100 g/L. Other chemical additives can be added to the solution to stabilize the etching process. The etching process is carried out for a predetermined time at a temperature between 30 and 90 degrees centigrade until the blind holes are formed to a desired depth. The etching solution can instead be an acid solution, such as a hydrochloric acid, a hydrofluoric acid, or a nitric acid solution. Then again, a conventional electrochemistry etching process can also be used.

In step 68, a solvent, such as methylbenzene, is used to wash the aluminum substrate, thereby removing the reminder of the protective film on the aluminum substrate. The finished cover 1 as shown in FIG. 1 is thus obtained.

Further optional steps can be used to prevent the obtained cover 1 from becoming oxidized. Such steps can include applying a protective top layer to the cover 1. Such a protective top layer can be an acrylic acid clear paint or a polyurethane clear paint. Additionally, a colored pattern can also be applied on the cover 1 for decoration, if desired, by spraying or painting.

Another preferred method for preventing the cover 1 from becoming oxidized is to anodize the cover 1. To anodize the cover, the cover 1 is dipped into an electrolytic cell containing sulfuric acid, and direct current power is applied to the electrolytic cell. A concentration of the sulfuric acid in the electrolytic cell is in a range of 100 to 200 g/L, a voltage of the direct current power applied to the electrolytic cell is between 8V and 16 V, and a current density of the direct current power is between 100.0 A/m² and 200.0 A/m². The anodization is carried out for 30 to 60 minutes, until an anodic oxide film is formed on the surface of the cover 1, and a thickness of the anodic oxide film is in a range of 8 μm to 20 μm. To form a colored cover 1, a coloring process is needed. After being anodized, the cover 1 is washed, dried, and then soaked in a dyeing bath containing organic dyes to color the anodic oxide film. A concentration of the organic dyes is between 1 g/L to 10 g/L. The dyeing process is performed for 5 to 20 minutes. Various organic dyes can be used according to the desired colors of the anodized surface of the metal cover. For instance, if the organic dyes are composed of aluminum red GLW and aluminum violet CLW, the color of the anodized surface of the cover 1 will be red. It is understood that other anodization processes can be used in place of the above anodization process, and other conventional coloring methods, such as electrolytic coloring, integral coloring, or inorganic dye coloring, can also be used to color the anodic oxide film. Thereafter, the anodized surface of the cover 1 is sealed in boiling water. Such treatments as described above can result in a brilliant appearance and a high luster of the cover 1.

The metal cover 1 can be made from a metal substrate, as described above, or can be a plastic base formed by injection molding with a metallic covering thereon.

In other preferred embodiments of the present invention, the method of manufacturing the metal cover 1 of FIG. 1 comprises the steps described above and in FIG. 2, but wherein the stamping and grinding process described for step 60 above can be performed in any other step. Thus, step 60 can just include cutting a piece of aluminum sheet into a plurality of aluminum substrates about the size of the cover 1 and then pretreating them as described above.

Compared to conventional methods, the method of the present invention can form a metal cover 1 with blind holes 3 therein using etching of the metal substrate, which is relatively low-cost and suitable for either mass production or production in small quantities. Additionally, a metal cover 1 manufactured using the method of the present invention can exhibit a brilliant appearance with a high luster. If the metal cover 1 is used as a cover for an electronic device or is assembled on the electronic device, the device can thereby be made more attractive to a user.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A method of manufacturing a metal cover with blind holes therein comprising the steps of: preparing a metal substrate; covering the metal substrate with a protective film; forming holes in the protective film according to the pattern of the blind holes to be formed in the metal cover leaving a remainder of the protective film, thus exposing the metal surface through the holes; etching the metal substrate in the exposed areas to form blind holes; and removing the remainder of the protective film on the metal substrate, thus obtaining the finished metal cover.

2. The method of manufacturing a metal cover with blind holes therein as claimed in claim 1, wherein a stamping process and a grinding process are further involved in any of said steps.

3. The method of manufacturing a metal cover with blind holes therein as claimed in claim 1, wherein the protective film protects the metal substrate from being etched in areas covered by the protective film.

4. The method of manufacturing a metal cover with blind holes therein as claimed in claim 1, wherein the holes in the protective film are through holes and are formed using a laser engraving process.

5. The method of manufacturing a metal cover with blind holes therein as claimed in claim 4, wherein the laser engraving process includes steps of programming a computer to execute a pattern procedure for directing a laser beam at the substrate in an intended pattern of the blind holes in the cover and directing a laser beam at the metal substrate and substantially burning off the protective film on the areas of the metal substrate where blind holes will be formed.

6. The method of manufacturing a metal cover with blind holes therein as claimed in claim 1, wherein the holes in the protective film are formed using machining methods.

7. The method of manufacturing a metal cover with blind holes therein as claimed in claim 1, wherein the metal substrate is etched in an alkali solution.

8. The method of manufacturing a metal cover with blind holes therein as claimed in claim 7, wherein the alkali solution is a sodium hydroxide solution, a concentration of the free sodium hydroxide is in a range of 10 to 100 g/L, and the etching temperature is between 30 and 90 degrees centigrade.

9. The method of manufacturing a metal cover with blind holes therein as claimed in claim 1, wherein the metal substrate is etched in an acid solution.

10. The method of manufacturing a metal cover with blind holes therein as claimed in claim 1, wherein the remainder of the protective film is removed by washing the metal substrate in a solvent.

11. The method of manufacturing a metal cover with blind holes therein as claimed in claim 1, further comprising a step for covering over the metal cover with a protective top layer after removing the remainder of the protective film.

12. The method of manufacturing a metal cover with blind holes therein as claimed in claim 11, wherein the protective top layer is an acrylic acid clear paint or a polyurethane clear paint.

13. The method of manufacturing a metal cover with blind holes therein as claimed in claim 11, further comprising a step of applying a colored pattern on the metal cover after removing the remainder of the protective film.

14. The method of manufacturing a metal cover with blind holes therein as claimed in claim 1, further comprising a step for anodizing the metal cover after removing the remainder of the protective film.

15. The method of manufacturing a cover with blind holes therein as claimed in claim 14, further comprising a step of coloring the cover using electrolytic coloring, dye coloring or integral coloring after anodization.

16. A method of manufacturing a metal cover with blind holes therein comprising the steps of: preparing a metal substrate; covering the metal substrate with a protective film; forming through holes in the protective film to expose the metal surface where the holes are formed and leaving a remainder of the protective film; etching the metal substrate in the exposed areas to form blind holes; and removing the remainder of the protective film on the metal substrate.

17. The method of manufacturing a metal cover with blind holes therein as claimed in claim 16, wherein the through holes in the protective film are formed using a laser engraving process or machining methods.

18. The method of manufacturing a metal cover with blind holes therein as claimed in claim 16, wherein the metal substrate is etched in an alkali solution or in an acid solution.

19. An intermediate device of a final cover, comprising:
a raw cover made of material being machinable via an etching procedure, and
including a main plane with a circumferential wall extending upwardly from a periphery of the main plane; and
a protective film applied on the whole main plain, said protective file made of material being removable via a laser engraving process while resistant to said etching procedure.
